(19) United States
(12) Patent Application Publication
(10) Pub. No.: US 2003/0163415 A1
(43) Pub. Date: Aug. 28, 2003

(54) System and method for transfer of funds between individuals

(76) Inventors: Ramy Shanny, Washington, DC (US); Leonard Lynch, Alexandria, VA (US); Marc A. Rossi, Ashburn, VA (US)

Correspondence Address: ROSSI & ASSOCIATES, P.O. Box 826, Ashburn, VA, 20146-0826, US

(21) Appl. No.: 10/081,931

(22) Filed: Feb. 22, 2002

(51) Int. Cl. G06F 17/60

(52) U.S. Cl. 705/39

(57) ABSTRACT

The invention provides a system and method for the transfer of funds between individuals in an efficient, effective and economical manner. The system includes a transmitting data entry device for entering transmitting transfer data identifying a first personal account of a first individual into a transfer coordinator device, and a receiving data entry device for entering receiving transfer data identifying a second personal account of a second individual into the transfer coordinator device. In addition, amount data corresponding to a monetary amount to be transferred from the first personal account of the first individual to a second personal account of a second individual is entered into the transfer coordinator device. A mechanism is provided for transferring the monetary amount from the first personal account to the second personal account based on the transmitting transfer data and the receiving transmitting data entered into the transfer coordinator device.

### BACKGROUND

The present invention is directed to providing a system and method for transferring monetary funds between individuals in an effective, efficient and economical manner. More specifically, the invention provides a system and method for effectively and efficiently transferring monetary funds between individuals without requiring the use of conventional forms of commercial paper or electronic transfers.

The advent of the Internet has lead the rapid development of direct electronic commerce between individuals. Internet auctions sites, for example, allow an individual to place an item up for sale and to receive bids from individuals located all over the world. Once a successful sale has been completed, however, it is then necessary to find an efficient mechanism for transferring funds directly from the buying individual to the selling individual in a secure manner. In addition, the mechanism for funds transfer must provide the individual receiving payment with a high degree of confidence that the payment is in fact valid.

One could, of course, forward payment in cash to the selling party through conventional mail or private delivery services. Sending cash, however, always entails a certain degree of risk that the payment will be stolen. Further, if the transaction is between individuals in different countries, the monetary units forwarded by the buyer may not be acceptable to the seller, which would require either the buyer or the seller perform a currency conversion to the appropriate monetary units. In addition, cash payments are delayed by the requirement for manual transportation and delivery of the cash payment from the buyer to the seller.

The probability of theft can be reduced by sending a personal check instead of cash payment. The use of a personal check, however, does nothing to overcome the problems of transport and currency conversion associated with cash payments. In addition, personal checks are not advantageous to the seller, as the seller must wait to make sure the personal check clears in order to insure valid payment has been received. The buyer could provide a certified check or a bank check, but obtaining these types of special checks is both inconvenient and costly. In some cases, the bank service fees may exceed the amount the buyer is paying the seller.

Clearly, it would be advantageous to permit the buyer to transfer funds electronically directly from the buyer's personal account to the personal account of the seller. One conventional mechanism to provide for electronic funds transfer is through the use of a wire transfer, wherein the buyer notifies his bank to electronically transfer funds to the account of the buyer. Again, wire transfer payments are generally not that convenient to make, as the seller must receive the buyer's account information and then must instruct his bank to make payment. In addition, fees for wire transfers (like certified checks and bank checks) are usually too high to be practical for small monetary transactions.

Attempts have been made to develop some form of electronic money to handle small transactions. Many of these systems, however, require both individuals to maintain special accounts, subscribe to a particular service or utilize proprietary transfer techniques in the form of special debit cards. In addition, in many instances it is possible to only transfer funds to individuals that subscribe to the same service.

Since a high percentage of individuals already have credit card accounts, the most convenient method of payment would be to have the seller simply charge the buyer's credit card account. The current system in place to facilitate credit card transactions, however, would require that the seller obtain the necessary certification from the financial institution issuing the credit card to permit charge transactions. The only system currently in place in the conventional marketplace requires the seller to open a merchant account relationship with the financial institution issuing the credit card Opening a merchant account, however, is not practical or economically feasible for individuals who only require to charge several transactions per each year.

In addition to the type of commercial transactions described above, there are numerous other instances in which one individual may wish to transfer small sums of money to another individual. A typical example is the case of a parent that wants to send small amounts of spending money to a college student. Alternatively, two individuals in the same household may want to transfer small sums of money between one another in a form other than cash.

In view of the above, it would be desirable to provide a system and method that would permit the transfer of funds between individuals in an efficient, effective and economical manner, without the drawbacks associated with cash payments, commercial paper and conventional forms of electronic funds transfer.

### SUMMARY OF THE INVENTION

The invention provides a system and method that would permit the transfer of funds between individuals in an efficient, effective and economical manner, without the drawbacks associated with cash payments, commercial paper and conventional forms of electronic funds transfer.

Specifically the invention is directed to a system for transferring monetary funds that includes a transmitting data entry device for entering transmitting transfer data identifying a first personal account of a first individual into a transfer coordinator device, and a receiving data entry device for entering receiving transfer data identifying a second personal account of a second individual into the transfer coordinator device. In addition, amount data corresponding to a monetary amount to be transferred from the first personal account of the first individual to a second personal account of a second individual is entered into the transfer coordinator device utilizing at least one of the transmitting data entry device and the receiving data entry device. A mechanism is provided for transferring the monetary amount from the first personal account to the second personal account based on the transmitting transfer data and the receiving transmitting data entered into the transfer coordinator device.

In a preferred embodiment, the first personal account comprises a personal credit card account of the first individual and the second personal account comprises a personal credit card account of the second individual. It will be understood, however, that other types of personal accounts may be readily utilized.

The transmitting transfer data includes account identification data and personal identification data corresponding to the first personal account and the receiving transfer data includes account identification data corresponding to the second personal account.

In cases where the transmitting transfer data and the receiving transfer data are entered into the transfer coordinator device at different times, a temporary file is generated to temporarily store at least one of the transmitting transfer data and the receiving transfer data. A file identifier is also generated that corresponds to the temporary file and can be utilized by the individual performing the later data entry to match their data with the earlier entered data.

The file identifier is preferably conveyed to at least one of the first individual and the second individual using electronic mail transfer. Accordingly, the electronic mail address of at least one of the first individual and the second individual is also entered into the transfer coordinator device.

In cases where the transmitting data entry device is a device separate, distinct and remotely located from the device that constitutes the receiving data entry device, data is preferably transmitted between the respective devices and the transfer coordinator device in a conventional manner over the Internet.

Various features and advantages of the invention will become apparent to those skilled in the art from the following detailed description of the preferred embodiments of the invention and the accompanying drawings.

### BRIEF DESCRIPTION OF THE DRAWINGS

The invention will be described in greater detail with reference to certain preferred embodiments thereof and the accompanying drawings, wherein:

FIG. 1 is a schematic block diagram of a first embodiment of the invention;

FIG. 2 illustrates a personal account transfer interface window that may be utilized in the first embodiment of the invention for data entry purposes;

FIG. 3 is a schematic block diagram of a second embodiment of the invention in which remote data entry devices are utilizes;

FIG. 4 is a flow diagram illustrating the entry of transfer data by an individual that is transferring funds using the embodiment illustrated in FIG. 3;

FIG. 5 is a flow diagram illustrating the entry of transfer data by an individual that is receiving funds using the embodiment illustrated in FIG. 3; and

FIG. 6 is a flow diagram illustrating a further embodiment implemented using automated teller machines as data entry devices.

### DETAILED DESCRIPTION OF THE PREFERRED EMBODIMENTS

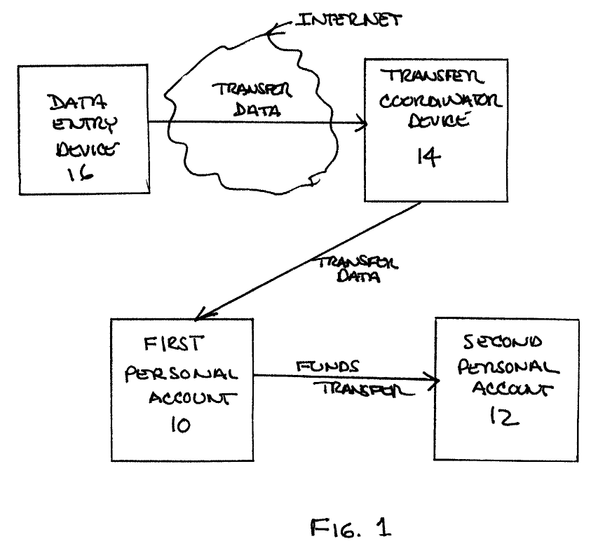

An implementation of a first embodiment of the invention is illustrated in block diagram form in FIG. 1. As shown in FIG. 1, a first individual has a conventional first personal account 10, for example a credit card account, a debit card account, a brokerage account, etc., associated with a conventional financial institution. Similarly, a second individual has a conventional second personal account 12 located in a conventional financial institution. The coordination of the transfer of funds from the first personal account 10 to the second personal account 12 is controlled by a transfer coordinator device 14. A first data entry device 16 is provided to permit the first individual to enter transaction data into the transfer coordinator device 16, which is used by the transfer coordinator device 14 to transfer funds from the first personal account 10 to the second personal account 12.

The first data entry device 16 may comprise, for example, a personal computer, handheld computer, personal digital assistant, telephone or any other device that permits the first individual to transmit the transaction data to the transfer coordinator device 14. The transfer coordinator device 14 may comprise an computer, server or similar processing device than can control the transfer of funds between the first personal account 110 and the second personal account 12, either by directly controlling the transfer of funds between accounts or indirectly by issuing instructions to processing devices of the institutions in which the personal accounts are held to effect the transfer. The transaction data utilized by the transfer coordinator device 14 includes an account identifier for the first personal account 10 an account identifier for the second personal account 12 and the amount to be transferred.

As just one example, the first data entry device 16 is a personal computer, the transfer coordinator device 14 is a server located at a facility of an Internet Service Provider (ISP) and the first personal account 10 and the second personal account 12 are respectively credit card accounts located at different financial institutions. An individual uses the first data entry device 16 to connect with the transfer coordinator device 14 via an Internet connection and enters the relevant account information and the amount of funds to be transferred. The transfer coordinator device 14 transmits the transfer data to the financial institution holding the first personal account 10, and the financial institution transfers the funds to the financial institution holding the second personal account 12 using conventional data networks. The amount transferred is debited from the first personal account 10 and credited to the second personal account 12. Accordingly, an individual can directly debit his own personal credit card for funds that are to be paid directly to a credit card account of a second individual.

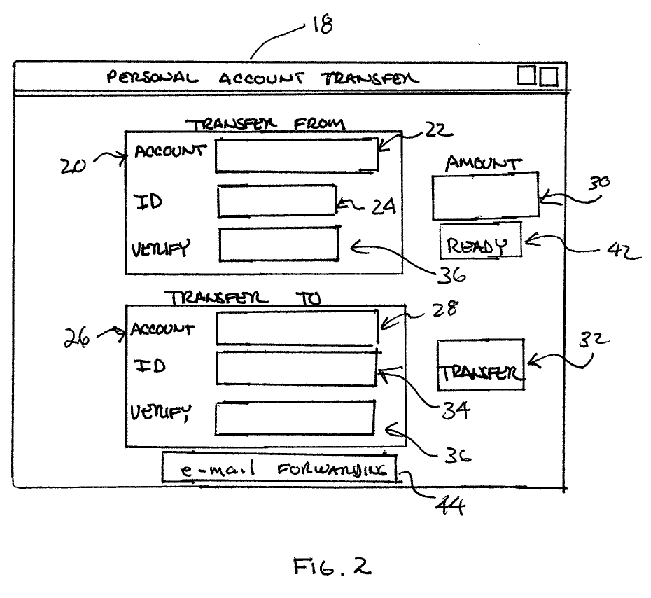

FIG. 2 illustrates a simple example of a personal account transfer interface window 18 that would be utilized on a personal computer in order to enter the transfer data. The personal account transfer interface window 18 includes a “Transfer From” data entry block 20 including a transfer account field 22 and a personal identification field (ID) 24, a “Transfer To” data entry block 26 including a receiving account field 28, and a transfer amount field 30. In order to transfer funds, the relevant information into the appropriate fields in both data entry blocks and a transfer button 32 (or similar icon) is clicked in order to initiate the transfer operation. A verification of the completion of the transfer can also be provided if so desired.

The above-described system provides unique advantages over conventional monetary transfer mechanisms. The individuals are simply charging and receiving credit on their own individual credit card accounts without requiring either individual to become a merchant account holder. The funds are efficiently transferred without the delays associated with cash payments or checks. The individual receiving the funds is guaranteed of the validity of the payment with the credit card issuer having the ultimate responsibility of collecting from the individual transferring the funds. The funds can be transferred anywhere in the world, and automatic exchange rate conversions can be accomplished as is done with conventional credit card transactions. In addition, the architecture is open to either individual being the party that is initiates transfer, namely, it is also possible for the individual that is to receive funds to provide the transfer data to the transfer coordinator device 14 in order to receive funds from the individual that is paying the funds. Alternatively, both individuals may utilize the data entry device 16 to enter their own respective account information.

In the scenario described above, a single data entry device 16 is utilized to enter the account information for both individuals. A parent, for example, may wish to send money to a child that is a student at a university located remote from the parent, wherein the parent is in possession of the child's account information. Instead of sending cash or a check, the parent can simply log onto the Internet, access a website of the transfer coordinator device 14, cause the personal account transfer interface window 18 to be opened, enter the relevant transfer data, and initiate the transfer. Similarly, the student as the receiving party can also perform the transfer operation if in possession of the parent's account information. In such a case, the “Transfer To” data entry block 26 is also provided with a personal ID field identification field 34. Further, both the parent and student may utilize the same personal computer to input their respective account information at the same time, for example, when the student is home from the university on vacation.

In other cases, however, the individual transferring the funds may not be in possession of the account information of the individual to which the funds are to be transferred. Further, in cases in which the two individuals involved are not intimately associated with one another, one individual may be reluctant to give or display their account information to the other individual. In such a case, it is preferable that the actual data being entered not be displayed in on the personal account transfer interface window if a single data entry device is being used by both parties. Instead, a marker such as an “X” or “*” may be displayed in the relevant fields when an individual is entering the data. A verification field 36 can be used to have an individual retype the account information and/or ID information in order to verify the correct information has been entered. For example, an individual may want to reimburse a friend a small amount of money owed. Both individuals can utilize a common data entry device with each entering their respective information in a manner that does not disclose their account information to the other individual.

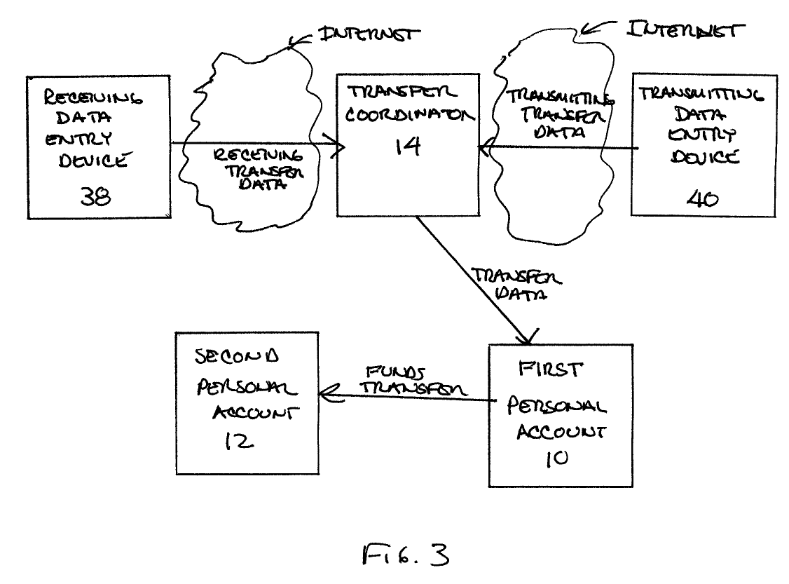

One of the main advantages of the invention is the ability to enable transfer of small sums of money conveniently and efficiently between parties that are remotely located from one another. Accordingly, as shown in FIG. 3, the individual receiving the funds can utilize a receiving data entry device 38 that is remote from a transmitting data entry device 40 associated with an individual that is transmitting the funds. The individual transmitting the funds would utilize the transmitting data entry device 40 to access the transfer coordinator device 14 and enter the required transfer data associated with the first personal account 10, while the individual receiving the funds would utilize the receiving data entry device 38 to access the transfer coordinator device 14 and enter the required transfer data associated with the second personal account 12.

While it is possible to have both individuals access the transfer coordinator device 14 essentially simultaneously to fill in the required account information, a more practical approach is to allow one of the individuals to access the transfer coordinator device 14, store their information, and then send a notification to the other individual telling them the transfer process has been initiated. As just one example, a seller advertises an item for sale on an auction site and receives an acceptable bid. The seller advises the buyer via electronic mail that their bid was accepted and requests payment. The buyer accesses the transfer coordinator device 14 (for example an ISP server), fills in their account information and the amount to be transferred, and hits a transfer ready button 42 provided on the personal account transfer interface window 18 as shown in FIG. 2. The buyer then logs out of the transfer coordinator device 14.

The transmitting data entered by the buyer is kept in a temporary file with an associated file identifier that is provided to the buyer. For example, the file identifier may be forwarded by e-mail to the buyer or simply displayed on the personal account transfer interface window 18 to verify completion of the entry of the transmitting data. The buyer then sends a message to the seller, for example by electronic mail, advising them that the transfer is ready and giving the seller the file identifier.

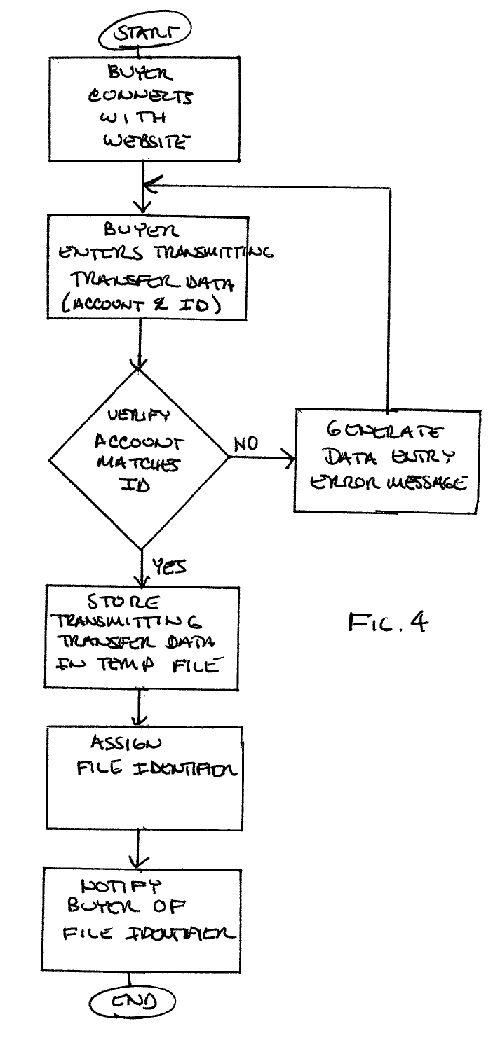

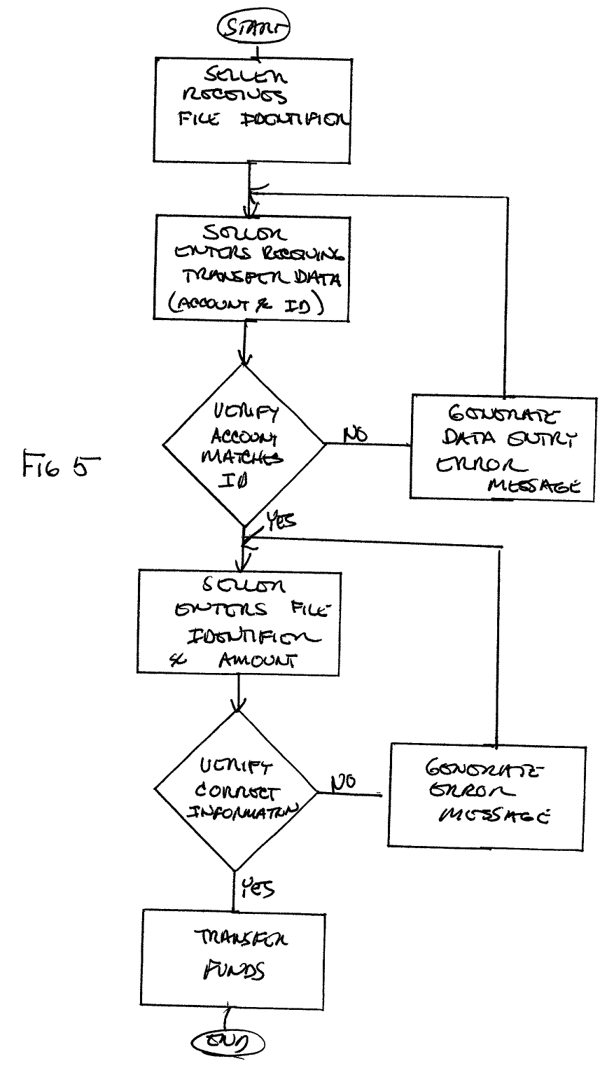

The seller then logs onto the transfer coordinator device 14, enters the file identifier, enters their account information, and hits the transfer button 32. Transfer is then initiated to transfer the funds from the first personal account 10 of the buyer to the second personal account 12 of the seller by the transfer coordinator device 14. For added security, the seller may be required to enter some additional item of information related to the transaction. For example, the seller may be required to also enter the amount of the transaction. Transfer is not initiated if the amount does not match the amount contained in the temporary file for the entered file identifier. FIGS. 4 and 5 are flow diagrams illustrating the above-described process.

The process can be further simplified by including an e-mail forwarding field 44 on the personal account transfer interface window 18. The buyer could then enter the seller's e-mail address into the e-mail forwarding field 44 to permit the file identifier to be directly transferred to the seller. Accordingly, the buyer can complete all requirements of the transfer, including notification to the seller of the file identifier, using a single interface window.

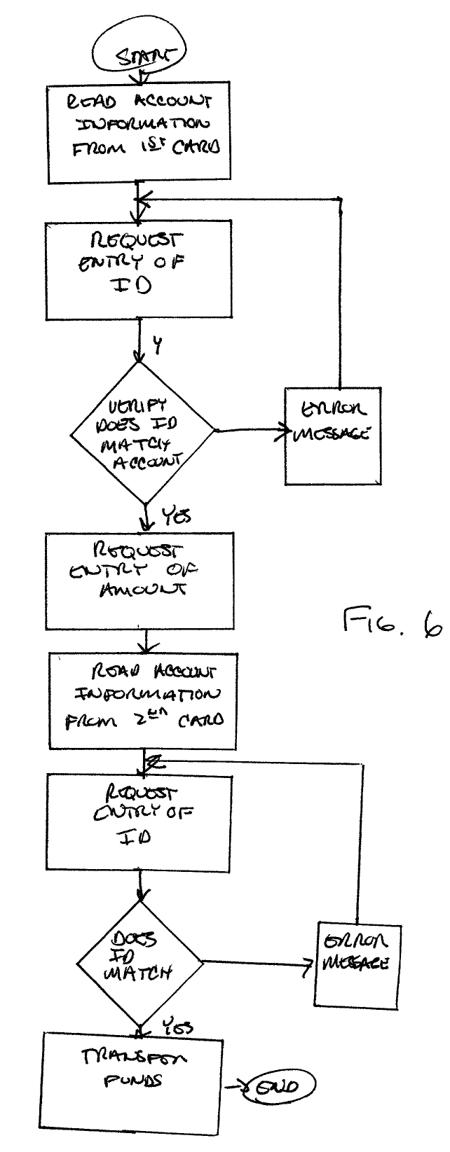

It will be understood that number of variations of the basic architecture are possible. For example, the data entry device may take the form of an automated teller machine (ATM) that is modified to include the personal account transfer function. As ATM machines are equipped with card readers, the account information can be conveniently read directly from each individuals credit card. FIG. 6, for example, illustrates a simple method of incorporating of the invention in a conventional ATM.

As shown in FIG. 6, a first individual inserts his credit card into an ATM. The card reader in the ATM reads the credit card account information of the first individual and prompts the first individual for an ID. The first individual enters an ID to initiate further action. The ATM then requests the amount of money to be transferred. The first individual enters the amount and the first individual's card is returned. A second individual is then prompted to enter their card which is read by the card reader to obtain the second individual's account information. The second individual is then prompted for their ID. Once the account information is verified, the transaction is initiated to transfer funds from the first individuals personal account to the second individuals personal account.

It will be understood that ATM's can also be utilized as data entry devices at separate locations in a manner similar to that described with respect to FIG. 3, thereby eliminating the necessity for one or both of the individuals to have Internet access. As ATM's are readily available throughout the world, anyone with a credit card could quickly and efficiently transfer funds by charging their own credit card account and crediting the credit card account of a receiving party.

The availability of inexpensive credit card readers can even permit the use of readers on personal computing devices. A home personal computer, for example, can be equipped with a credit card reader so that family members may easily transfer funds between one another without requiring manual entry. Alternatively, a dedicated public kiosk including a card reader can be provided as the data entry device to allow individuals to transfer funds between one another at convenient locations such as shopping malls, airports or public arenas.

The invention has been described in detail with reference to certain preferred embodiments thereof. It will be understood, however, that modifications and variations are possible within the scope of the appended claims. For example, while the illustrated embodiments concentrated on the use of credit card accounts, it will be appreciated that the invention is applicable to permit the direct transfer of funds from any type of personal account of a first individual to any type of personal account of a second individual. The use of established credit card accounts, however, is particularly advantageous due to their ready availability and the infrastructure and architecture that is already in place to allow credit card transactions. Further, while the preferred embodiment utilize computing devices and the Internet to input and transfer data, the invention is applicable to all types of data entry devices and networks. Conventional telephones, for example, may be used to enter account information to a transfer coordinator device either by manual entry or by using voice recognition techniques. Still further, in the embodiment in which the transmitting transfer data and the receiving transfer data are independently entered, the order in which that data is entered and stored in a temporary file is not significant, namely, either the transmitting transfer data or the receiving transfer data may be entered first.

What is claimed is:

1. A method of transferring monetary funds comprising:
entering transmitting transfer data identifying a first personal account of a first individual into a transfer coordinator device utilizing a transmitting data entry device;
entering receiving transfer data identifying a second personal account of a second individual into the transfer coordinator device utilizing a receiving data entry device;
entering an amount data corresponding to a monetary amount to be transferred from the first personal account of the first individual to a second personal account of a second individual into said transfer coordinator device utilizing at least one of the transmitting data entry device and the receiving data entry device; and
transferring the monetary amount from the first personal account to the second personal account based on the transmitting transfer data and the receiving transmitting data entered into the transfer coordinator device.

2. A method of transferring monetary funds as claimed in claim 1, wherein the first personal account comprises a personal credit card account of the first individual and the second personal account comprises a personal credit card account of the second individual.

3. A method of transferring monetary funds as claimed in claim 1, wherein the transmitting transfer data includes account identification data and personal identification data corresponding to the first personal account and the receiving transfer data includes account identification data corresponding to the second personal account.

4. A method of transferring monetary funds as claimed in claim 1, wherein the transmitting transfer data and the receiving transfer data are entered into the transfer coordinator device at different times.

5. A method of transferring monetary funds as claimed in claim 4, further comprising generating a temporary file to temporarily store at least one of the transmitting transfer data and the receiving transfer data and generating a file identifier that corresponds to the temporary file.

6. A method of transferring monetary funds as claimed in claim 5, further comprising conveying the file identifier to at least one of the first individual and the second individual.

7. A method of transferring monetary funds as claimed in claim 5, further comprising accessing the temporary file using the file identifier and matching the transmitting transfer data to the receiving transfer data.

8. A method of transferring monetary funds as claimed in claim 6, wherein the file identifier is conveyed via electronic mail transfer.

9. A method of transferring monetary funds as claimed in claim 8, further comprising entering an electronic mail address of at least one of the first individual and the second individual into the transfer coordinator device.

10. A method of transferring monetary funds as claimed in claim 1, wherein the transmitting data entry device is separate, distinct and remotely located from the receiving data entry device.

11. A system for transferring monetary funds comprising:
a transmitting data entry means for entering transmitting transfer data identifying a first personal account of a first individual into a transfer coordinator device;
a receiving data entry means for entering receiving transfer data identifying a second personal account of a second individual into the transfer coordinator device;
wherein amount data corresponding to a monetary amount to be transferred from the first personal account of the first individual to a second personal account of a second individual is entered into said transfer coordinator device utilizing at least one of the transmitting data entry means and the receiving data entry means; and
means for transferring the monetary amount from the first personal account to the second personal account based on the transmitting transfer data and the receiving transmitting data entered into the transfer coordinator device.

12. A system for transferring monetary funds as claimed in claim 11, wherein the first personal account comprises a personal credit card account of the first individual and the second personal account comprises a personal credit card account of the second individual.

13. A system for transferring monetary funds as claimed in claim 11, wherein the transmitting transfer data includes account identification data and personal identification data corresponding to the first personal account and the receiving transfer data includes account identification data corresponding to the second personal account.

14. A system for transferring monetary funds as claimed in claim 11, wherein the transmitting transfer data and the receiving transfer data are entered into the transfer coordinator device at different times.

15. A system for transferring monetary funds as claimed in claim 14, further comprising means for generating a temporary file to temporarily store at least one of the transmitting transfer data and the receiving transfer data and means for generating a file identifier that corresponds to the temporary file.

16. A system for transferring monetary funds as claimed in claim 15, further comprising means for conveying the file identifier to at least one of the first individual and the second individual.

17. A system for transferring monetary funds as claimed in claim 15, further comprising means for accessing the temporary file using the file identifier and matching the transmitting transfer data to the receiving transfer data.

18. A system for transferring monetary funds as claimed in claim 16, wherein the file identifier is conveyed via electronic mail transfer.

19. A method of transferring monetary funds as claimed in claim 18, further comprising means for entering an electronic address of at least one of the first individual and the second individual into the transfer coordinator device.

20. A method of transferring monetary funds as claimed in claim 11, wherein the transmitting data entry means is a device separate, distinct and remotely located from the receiving data entry means.
